(19) United States
(12) Patent Application Publication
(10) Pub. No.: US 2024/0326733 A1
(43) Pub. Date: Oct. 3, 2024

(54) AIRBAG SYSTEM WITH CUSTOM TEAR RESISTANCE

(71) Applicant: Toyota Motor Engineering & Manufacturing North America, Inc., Plano, TX (US)

(72) Inventors: Phouvadol P. Khouphongsy, Saline, MI (US); Yuyang Song, Ann Arbor, MI (US); Danil V. Prokhorov, Canton, MI (US); Umesh N. Gandhi, Farmington Hills, MI (US); Mizuho Takayama, Ann Arbor, MI (US); Shinnosuke Shimokawa, Ann Arbor, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/128,741

(22) Filed: Mar. 30, 2023

(51) Int. Cl. B60R 21/235

(52) U.S. Cl. CPC B60R 21/235; B60R 2021/23542

(57) ABSTRACT

Various embodiments of an airbag system provide a hollow body that is constructed of a textile material having a first tear resistance value prior to application of a dilatant material onto the hollow body. The dilatant material may be present on less than an entirety of the hollow body and provide the hollow body with a second tear resistance value that is greater than the first tear resistance value after application of the dilatant material.

### TECHNICAL FIELD

The subject matter described herein relates, in general, to deployable airbags and, more particularly, to airbags with a custom ventilation to provide robust tear resistance and optimized energy absorption.

### BACKGROUND

As humans have traveled to higher altitudes and to faster speeds, the threat of harm from impacts has grown. Advancements in material construction have provided an ability to mitigate impact damage in some circumstances. The proliferation of inflatable vessels, such as airbags, balloons, or cushions, to absorb impact energy further allows for the reduction in impact damage. However, the use of various materials and inflatable members can experience excessive bulk and weight that degrades the comfort and/or safety performance. That is, some inflatable members can have ventilation characteristics that are sub-optimal for energy absorption while other inflatable members can be susceptible to material damage, such as rips, tears, and holes, that impair the ability of the member to provide energy absorption over time, as intended to provide optimal safety.

### SUMMARY

Example airbag systems generally relate to a manner of improving ventilation and tear resistance during deployment to provide optimized performance and safety.

In one embodiment, an airbag system has a hollow body that is constructed of a material having a first tear resistance value prior to application of a dilatant material onto the hollow body. The dilatant material is present on less than an entirety of the hollow body and provides the hollow body with a second tear resistance value that is greater than the first tear resistance value after application of the dilatant material.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIGS. 1A and 1B respectively illustrate an example environment within which systems and methods disclosed herein may be implemented.

FIGS. 2A & 2B respectively illustrate aspects of example airbags configured in accordance with some embodiments.

FIG. 3 plots operational data associated with an airbag system operated in accordance with assorted embodiments.

FIG. 4 illustrates a flowchart of an example method of use for an airbag system that can be conducted in accordance with various embodiments.

FIG. 5 illustrates a flowchart for an example method of fabrication that may be carried out to create some embodiments of an airbag system.

### DETAILED DESCRIPTION

Systems, methods, and other embodiments associated with improving the performance and durability of an airbag are disclosed herein. As previously described, conventional energy absorbing members, and particularly inflatable members, can be susceptible to physical damage that degrades the ventilation characteristics and safety performance of the member.

Accordingly, various embodiments of an airbag system are directed to customized ventilation characteristics that provide optimal safety performance with robust physical damage resistance and without adding excessive weight and bulk. The application of dilatant material to less than an entirety of an airbag allows energy absorption customization without degrading the physical characteristics of airbag deployment or being uncomfortable to wear by a user. The ability to customize energy absorption characteristics over time with the application of dilatant material to selected portions of an airbag provides optimized safety by lowering the airbag's susceptibility to damage from sharp objects. The customization of an airbag's ventilation performance can further provide safety with minimal physical bulk and weight that enhances comfort for users wearing one or more deployable airbags.

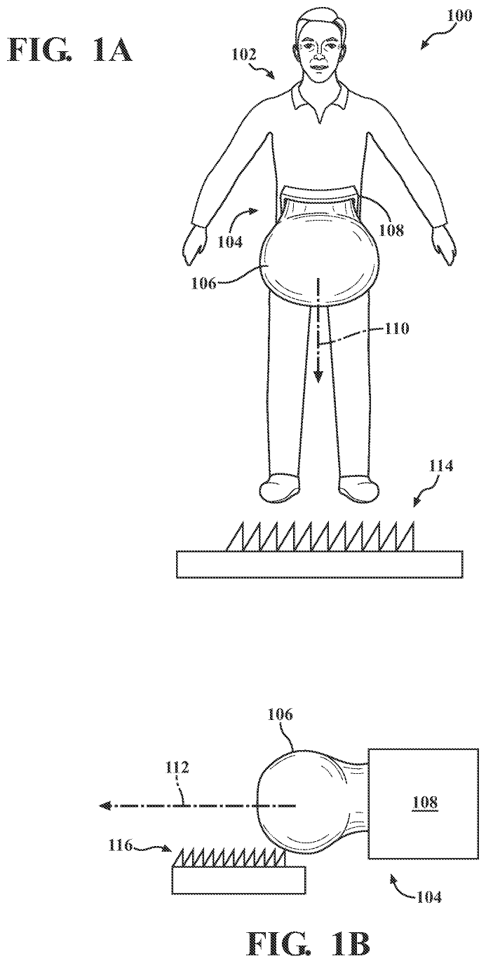

With reference to FIGS. 1A and 1B, an example airbag environment 100 is illustrated where one or more embodiments of an airbag system can be practiced. A user 102 can employ an airbag system in a variety of different, non-limiting or exclusive, manners. For instance, the user 102 can wear a garment in which one or more airbags 104 are packaged for deployment in response to a predetermined trigger, as shown in FIG. 1A. Another example packages one or more airbags 104 in proximity to the user 102, such as in a vehicle, to be deployed in response to detected, or predicted, safety events that threaten the safety of the user 102.

As shown, deployment of an airbag 104 can extend an airbag body 106 from an anchor structure 108 with a positive pressure event, such as an explosion or quick inflation release of compressed air. The volume of air used to inflate an airbag 104 allows force and energy to be absorbed by the airbag body 106 in response to physical displacement. Over time, the airflow characteristics of the airbag determine how air contained within the airbag body 106 dissipates, which corresponds with how energy is absorbed after initial impact and deformation of the airbag body 106.

When an airbag 104 deploys and operates without obstruction, the safety of the user 102 can be increased as relatively large amounts of energy are absorbed and dissipated quickly, such as in response to a fall, as indicated by arrow 110, or in response to a drastic change in velocity, as indicated by arrow 112. However, the presence of obstructions, objects, and surfaces that can impede or damage the airbag body 106 can puncture, tear, or otherwise open the material of the airbag body 106 in a manner that changes the ventilation characteristics of the airbag 104. For example, encountering a sharp rock 114, as illustrated in FIG. 1A, or impeding member 116, as illustrated in FIG. 1B, can increase the evacuation of air from the airbag body 106, which reduces the overall amount of energy that can be absorbed by the airbag. Such change in airbag ventilation can degrade the airbag's ability to sustain safety for the user 102 after initial impact, particularly in a fall situation where the user 102 may encounter several impacts in succession.

While not required or limiting, some embodiments of an airbag 104 are configured to provide optimal fall protection and safety for a user 102 that wears a garment employing one or more packaged airbag bodies 106. Upon detection of a fall with one or more sensors from a height, such as three meters, at least one airbag body 106 is deployed before hitting the ground, such as at two meters above the ground. The quick and full deployment of an airbag body can correspond with pressurization of an interior volume defined by the airbag body 106 to a predetermined pressure. Once the airbag body 106 touches a rigid object and/or surface 116, the airbag 104 deforms to absorb impact energy in proportion to the displacement of the airbag body 106. The ventilation characteristics of the airbag body 106, such as material, size, shape, pressure, and number of seams, collectively provide a ventilation value that corresponds with how easily air from within the airbag body 106 escapes and decreases the pressure within the interior volume of the airbag body 106.

As designed, an airbag 104 can have a ventilation value that provides energy absorption over time with a predetermined decay. That is, an airbag body 106 can be configured with a ventilation value that provides energy absorption capabilities beyond an initial impact and/or deformation of the airbag body 106. For instance, an airbag 104 can be constructed with a high ventilation value to allow relatively large emission of air from within the internal cavity of the airbag body 106 to absorb greater amounts of energy quickly during impacts or with a low ventilation value to absorb lower amounts of energy for a longer time and/or for more separate impact events.

Although an airbag body 106 can be customized to provide a ventilation value that provides different operational characteristics over time, the presence of objects, surfaces, and obstructions that alter the airbag body 106 can change the airbag's ventilation value and degrade the ability to safely absorb energy from a single impact or multiple separate impacts over time. In other words, tears, punctures, and rips in an airbag body 106 can change how pressurized air escapes and how much energy can be safely absorbed and dissipated by an airbag 104 over time. Hence, various embodiments are directed to increasing the resilience of an airbag body 106 to contact with objects, surfaces, and obstructions that could rip, tear, and otherwise open access to the interior volume defined by the airbag body 106.

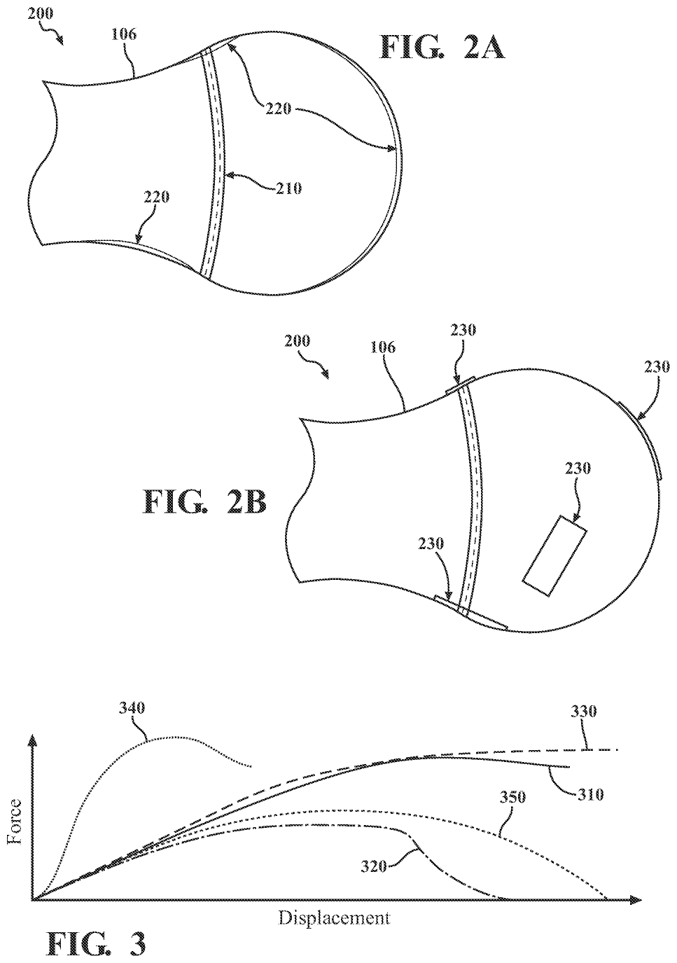

FIGS. 2A and 2B respectively illustrate portions of an example airbag system 200 that can be employed in various safety environments, such as the environment 100 conveyed in FIG. 1. The line representation of FIG. 2A illustrates how an airbag body 106 can be constructed with at least one seam 210 that joins two sheets of material, which can be any woven or extruded textile. A scam 210, in some embodiments, is stitched to connect different sheets of material, but such joining is not required as material sheets can be connected in any manner that is secure, such as adhesive, fasteners, mechanical clips, or magnets. The use of seams 210 can allow the airbag body 106 to be configured in a predetermined shape once pressurized after deployment. It is contemplated that the predetermined shape may provide increased safety in certain situations, such as fall impacts or deployment within a vehicle.

The size and shape of the airbag body 106 can contribute to certain arcas encountering obstacles and surfaces more than other areas of the airbag body 106. For instance, a bulbous side of the airbag body 106 may present a greater amount of surface area, with respect to the deploying anchor structure 108, than other portions of the body 106. As such, portions of the airbag body 106 can be more susceptible to encountering hazardous objects and surfaces than other portions. Accordingly, selected aspects of the airbag body 106 can be fortified against rips, tears, punctures, and cuts from physical engagement with external aspects.

In one, non-limiting, embodiment, a dilatant material, such as a shear thickening fluid or other non-Newtonian fluid, is applied to the woven material of the airbag body 106, such as nylon, to decrease the chance encountering a sharp edge will penetrate and open the body 106. As shown in FIG. 2A, the dilatant material 220 can be sprayed onto selected portions of the airbag body 106 and allowed to dry to allow particles to form a protective layer by attaching to the underlying airbag body 106 material. The use of sprayed material allows for the precise control of the location and thickness of dilatant material 220, which can customize the resistance to puncture and tears as well as customize the ventilation of the airbag body 106. Various embodiments spray the dilatant material 220 onto less than all the interior surface area of the airbag body 106 while other embodiments spray dilatant material 220 onto portions of the interior and exterior surfaces of the airbag body 106.

FIG. 2B illustrates how portions of an airbag body 106 can be reinforced against tears, rips, cuts, and punctures with one or more patches 230 that are adhered to the interior, or exterior, surface of the airbag body 106. A patch 230 can be any size, thickness, shape, and material construction that increase the tear, rip, and puncture resistance of the airbag body 106 to physical engagement with a sharp edge or point. A non-limiting embodiment of a patch 230 embeds dilatant material into a fabric, textile, or mesh that is sewn, glued, fastened, or otherwise attached to a selected region of the airbag body 106.

The ability to selectively utilize different applications of dilatant materials 230 with an airbag body 106 can provide custom tear resistance and air ventilation value as coated, or patched, regions of the body 106 will experience different air ventilation from uncoated and/or uncovered portions of the airbag body 106. For instance, portions of an airbag body 106 coated or patched can have reduced air ventilation values that correspond with pressure, and air volume, retention over time and in response to external force. Increased use of dilatant material 230 may further reduce the physical displacement of the airbag body 106 in response to external impact, which can reduce the amount of energy absorbed. Hence, an airbag 200 can have a customized ventilation value that allows for energy absorption over time catered to a particular safety situation, such as a user fall, vehicle collision, or user impact.

The customization of an airbag 200 may further provide a designed ventilation value without adding physical bulk or weight that degrades the airbag body's deployment speed or reliability. That is, portions of an airbag body 106 can enjoy heightened tear resistance and custom ventilation that is different than the material of the airbag body 106 without adding bulk and weight that can slow deployment and/or impede full inflation of the body 106 to the designed shape and size. It is noted that, compared to an airbag body 106 fully coated or covered with dilatant material, the customized application of dilatant material 230 can increase user comfort when the airbag 200 is worn prior to, and during, deployment.

Customization of the airbag body 106 with one or more sprayed and/or patched regions can mitigate potentially inconsistent seam 210 portions. That is, an attachment, connection, or groove between two sheets of material, which can be characterized as a scam 210, that provide shape and size to an airbag body 106 can exhibit varying ventilation, physical movement during deployment, and risk of opening in response to contact with a sharp edge or point. The customization of an airbag body 106 with a sprayed layer of dilatant material 220 or a patch 230 that spans a scam 210, as shown in FIG. 2B, can provide increased resistance to opening in response to sharp contact, provide a more consistent ventilation value, and increase the physical reliability of airbag deployment by physically stiffening portions of the airbag body 106 compared to untreated sheets of material.

FIG. 3 plots operational data corresponding with an airbag system configured and operated in accordance with various embodiments. The solid line 310 corresponds an airbag body that is constructed without the addition of any dilatant material and deployed without any tears, rips, or punctures that allow inadvertent air outflow from the airbag, once pressurized. The same airbag body that is untreated with dilatant material can encounter one or more inadvertent openings as a result of contact with a sharp element and exhibit reduced force dissipation and energy absorption, as illustrated by solid line 320. It is noted that the area under each line corresponds with the overall amount of energy dissipated by an airbag while the length of the respective lines, along the displacement (X) axis, corresponds with the time involved with dissipating energy and absorbing force (Y axis).

Through customization of the ventilation value of an airbag via the inclusion of dilatant material, the operational behavior and characteristics of an airbag can be altered from the default, untreated configurations conveyed by line 310 and line 320. As a non-limiting example, segmented line 330 corresponds with an airbag body treated with one or more sprayed layers and/or patches that provide dilatant material that both resists tears and punctures while providing a custom, non-default ventilation value that increases the overall amount of energy dissipated after airbag deployment. Customization of an airbag body with dilatant material can, alternatively, provide a ventilation value that increases the initial amount of force absorbed, but may have a shorter amount of time dissipating energy, as shown by segmented line 340.

It is contemplated that the addition of dilatant material, such as shear thickening fluid, can reduce the degrading effects of a puncture or tear. Segmented line 350 conveys how dilatant material can reduce the loss of pressurized gas in an airbag body despite an opening in the body occurring for any reason, such as seam separation, cut, rip, or puncture hole. As compared to line 320, the addition of dilatant material can mitigate the severity of an opening and retain some of the energy dissipating characteristics that allows the airbag to provide practical efficiency that can correspond with increased overall safety of a user.

The ability to customize an airbag with the application of dilatant material in strategically selected locations on an airbag body allows for optimization of safety while providing increased tear resistance. Such safety optimization, in some embodiments, can be provided with customized ventilation value associated with one or more layers and/or patches of dilatant material that adjust operating parameters from untreated, default energy dissipating characteristics. For example, an airbag can have a ventilation value customized for fall protection by having a lower amount of air leakage from the internal cavity of an airbag body for a longer amount of time than an untreated airbag body. Another non-limiting example, dilatant material can customize the ventilation value of an airbag to be conducive to vehicle collisions with relatively large airbag body displacement and energy dissipation for a short amount of time.

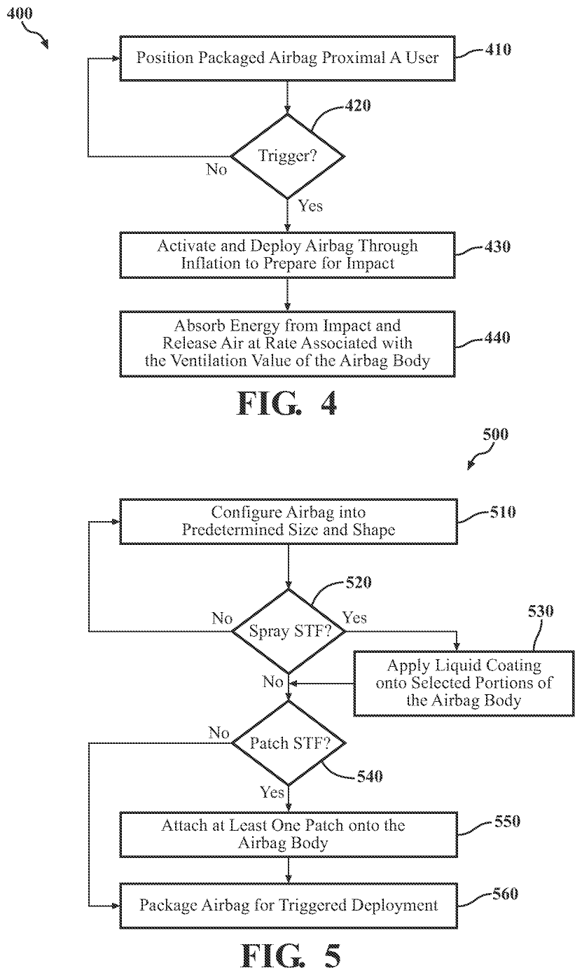

FIG. 4 illustrates a flowchart of an example airbag utilization routine 400 that can be conducted by assorted embodiments of the airbag system described in FIGS. 1-3. An airbag body packaged for deployment is initially positioned proximal a human user in step 410. It is noted that an airbag body utilized in step 410 can have a ventilation value customized with one or more layers and/or patches that introduce dilatant material that additionally increases tear resistance to portions of the airbag body.

The packaged airbag can remain undeployed for any amount of time and for any number of user activities until a triggering event or condition is encountered. Decision 420 evaluates if a trigger condition is present and automatically proceeds to activate airbag body deployment in step 430 in response. The event or condition that can cause decision 420 to inflate and deploy an airbag body in step 430 can, for example, consider one or more types of information detected by one or more sensors, such as pressure, acoustic, or mechanical sensors. It is contemplated that the triggering event for decision 420 is executed automatically and without interaction with a user or is manually initiated by a user, such as with a button, gesture, or verbal command.

In a non-limiting example, decision 420 detects a fall and inflates one or more airbags in step 430 that subsequently absorb energy in step 440 as a result of impact with an object or surface. Over time, an inflated airbag in step 440 is released from the internal cavity of the airbag body, as regulated by the ventilation value of the body. That is, step 440 maintains pressure and air volume in the internal cavity of an airbag body to absorb impact and dissipate energy over multiple impacts and/or application of external force.

FIG. 5 illustrates a flowchart of an example airbag fabrication routine 500 that can be executed to produce an airbag that can be utilized in the routine 400 of FIG. 4 to provide the operational characteristics of FIG. 3. Step 510 configures an airbag body with a predetermined size and shape. The construction of an airbag body in step 510 can involve joining one or more sheets of material, such as nylon, via a seam that is sewn or otherwise connected. Some embodiments of step 510 arrange an airbag body as a single continuous sheet of a woven textile without any sewn seams.

While an untreated airbag body can be inflated and deployed with a default ventilation value and tear resistance as part of an airbag system, various embodiments introduce a dilatant material, such as shear thickening fluid (STF), to selected portions of an airbag body to increase tear resistance and provide custom ventilation. Decision 520 determines if a layer of STF is to be sprayed onto the airbag body, as shown in FIG. 2A. If so, step 530 applies a liquid coating onto less than all the airbag body to provide tear resistance and custom ventilation. The execution of step 530 can involve spraying a predetermined thickness, or volume, of STF onto one or more regions of the airbag body to customize the operational characteristics and resistance to opening in response to physical contact with a sharp edge.

Once liquid STF is applied to one or more airbag body regions in step 530, or in the event no liquid STF is to be employed from decision 520, decision 540 evaluates if a patch is to introduce STF material to the airbag body. Step 550 proceeds to attach one or more patches embedded with STF onto less than all of the airbag body to provide custom ventilation value and robust tear resistance where the patch(es) are attached. That is, step 550 can sew or otherwise attach one or more patches with matching, or dissimilar, constructions to selected regions of an airbag body, such as regions identified as prone to contact with sharp aspects during airbag deployment and/or impact absorption. It is noted that the execution of step 550 can provide a combination of liquid STF and STF patches located on an internal, or external, surface of the airbag body.

Regardless of the number, location, and structure of the applied STF material, after decision 540 prompts the execution of step 550, or skips any application of an STF patch, step 560 packages the customized airbag body with an inflating aspect that allows for subsequent deployment in response to a triggering condition, as discussed with decision 420 of FIG. 4. Through the customization of the tear resistance and ventilation value of the airbag body via routine 500, the airbag system assembled in step 560 can provide optimized safety and performance without adding burdensome weight or bulk to the airbag package. In other words, the application of STF, or other dilatant material, to intelligently selected regions of an airbag body, instead of application of STF to the entirety of the airbag body, allows for quick and reliable inflation and airbag deployment.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-5, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. An apparatus comprising:
an airbag including a hollow body constructed of a material having a first tear resistance value; and
a dilatant material present on less than an entirety of the hollow body, the hollow body having a second tear resistance value that is greater than the first tear resistance value after application of the dilatant material.

2. The apparatus of claim 1, wherein the hollow body comprises woven textile.

3. The apparatus of claim 1, wherein the hollow body comprises multiple sheets of fabric joined by at least one seam.

4. The apparatus of claim 3, wherein at least one patch is positioned on an exterior surface of the hollow body, separated from the at least one seam, the at least one patch including the dilatant material.

5. The apparatus of claim 3, wherein the at least one patch is positioned on an exterior surface of the hollow body to span a first seam of the at least one seam.

6. The apparatus of claim 1, wherein the dilatant material is positioned on an interior surface of the hollow body.

7. The apparatus of claim 1, wherein the dilatant material is a shear thickening fluid.

8. The apparatus of claim 1, wherein the dilatant material is present in a first patch attached to the hollow body and a second patch attached to the hollow body, the first patch separated from the second patch.

9. The apparatus of claim 1, wherein the hollow body has a lower ventilation value after application of the dilatant material.

10. The apparatus of claim 1, wherein the dilatant material is present in a patch attached to the hollow body and as a layer formed on the hollow body, the patch and layer physically separated on the hollow body.
